(19) United States
(12) Patent Application Publication
(10) Pub. No.: US 2005/0152133 A1
(43) Pub. Date: Jul. 14, 2005

(54) Integrated greeting message and lighted jewelry box

(75) Inventors: Chang Kao, Boulder, CO (US); Stephanie Kao, Boulder, CO (US)

Correspondence Address: CHANG-YUNG KAO, 4565 PUSSYWILLOW COURT, BOULDER, CO, 80301, US

(73) Assignee: Chang Kao, Boulder, CO (US)

(21) Appl. No.: 10/707,800

(22) Filed: Jan. 13, 2004

(51) Int. Cl. F21V 33/00

(52) U.S. Cl. 362/155

(57) ABSTRACT

An improved jewelry box incorporates light sources to direct light rays at the jewelry contained, therein, when the jewelry box is opened. The improved jewelry box will also provide a customized greeting message post area. The customized greeting message can be a small printed message, engraved metal plate, or any other presentable materials. The box consists of a top section and a bottom section. The top and bottom sections are hinged together. The top section has an extended portion at its opening end. The bottom section has a shape to accommodated the shape of the top section therefore the jewelry box will still model a traditional jewelry box when it is closed. A light housing is mounted on the extended portion of the top section. The light housing consists of two LED light bulbs, power source, and an switch mechanism. The switch automatically cut off the electrical power when the box is closed.

### BACKGROUND OF INVENTION

1. Field of the Invention

This invention relates to jewelry boxes that are able to illuminated and customize greeting message inside the jewelry box, in particular.

2. Prior Art

Jewelry boxes are well known in the art. One particular type of jewelry box is especially adapted to contain a ring or similar item. This type of jewelry box has the top and bottom sections hinged joined together. The bottom section of the box is fairly deep so as to hold and retain a support pad which retains a ring. A portion of the ring extends above and is displayed above the support pad. The top section of the box is, typically, also fairly deep whereby the jewelry and setting displayed above the pad will not touched by the top section.

The hinge is typical an overcenter hinge which includes a leaf spring. This hinge arrangement is designed to forcefully cause the top and bottom sections to the open or close when a certain relative positioning of the sections occurs. Thus, the box is maintained in the open position or is alternatively forcefully put in a closed position, i.e. snapped shut. In the past, attempts have been made to enhance the marketability of jewelry items by creating boxes that are more attractive. In some cases, an illuminating device has been added to the box. However, in the past, the illumination devices have been relatively weak miniature lamps which provide little or no illumination. Also the lamp is mounted to the inside top section which means, the light rays come from the back of the presented jewelry. Likewise, the switch mechanism that activates the light source, has been designed as an add-on to an existing box or attached to the hinge. The prior art designs have been cumbersome, expensive, and generally ineffective. Also prior arts do not provide any greeting message to enhance the marketability.

3. Prior Art Statement

The following patents, listed in numerical order, were discovered in a preliminary search.

U.S. Pat. No. 712,112; Illuminated Watch Box; C. Arnold. This patent discloses an illuminated watch box.

U.S. Pat. No. 2,159,954; Vanity Case; W. A. Preisz. This patent discloses an illuminated vanity case.

U.S. Pat. No. 2,453,621; Illuminated Compact; O. W. Chinn. This patent discloses an illuminated compact.

U.S. Pat. No. 2,867,353; Display Box for Watches, ETC.; A. R. Botham. This patent discloses a display box with a transparent section.

U.S. Pat. No. 3,182,184; Purse Light; D. L. Echols et II. This patent discloses a lighted jewelry box.

U.S. Pat. No. 3,937,320; Lighted Jewelry Box; A. L. Chao et al. This patent discloses a lighted jewelry box.

U.S. Pat. No. 4,882,966; Musical Jewelry Box; B. Silverman. This patent discloses a musical jewelry box.

U.S. Pat. No. 4,917,459; Jewelry Display Device; S. G. Solitt et al. This patent discloses an illuminated jewelry display device.

U.S. Pat. No. 5,329,433 Lighted jewelry box, David L. Geeting; This patent discloses an improved lighted jewelry box.

### SUMMARY OF INVENTION

The present invention provides an improved jewelry box which includes Light Emitting Diode (LED) lights mounted, along with reflectors, in an extended portion of the top section of the hinged jewelry box. All of power source, electrical switch, and LED lights are mounted on the light housing conveniently. The light is activated when the box is opened and an electrical connection is made through the switch mechanism in the light housing. The electrical connection causes a power source to be electrically connected to the light. Conversely, when the box is closed, the electrical connection made by the switch mechanism is broken and the light is turned off.

The present invention, further provides a customizable greeting message posting area. The greeting message can be a pre-printed message, a customized printing message, or an engraved metal plate.

### BRIEF DESCRIPTION OF DRAWINGS

FIG. 1 is the perspective view of the invention shown with the top section opened.

FIG. 2 is the perspective view of the invention with the light housing separated from the main box.

FIG. 4. is the back view of the light housing showing the power source(batteries), switch mechanism, and LED lights.

FIG. 4. is the closer view of the switch mechanism. It shows when the top section of the jewelry box is down, then the half-ball detent on the bottom section will push the flexible conductive strip up. Therefore the power source is cut off to the LED lights.

### DETAILED DESCRIPTION

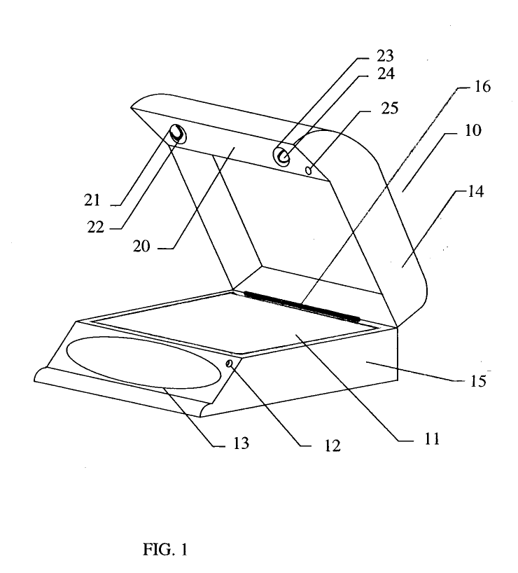

Referring to FIG. 1, There is shown a perspective view of the jewelry box in open position. An integrated greeting message and lighted jewelry box 10 includes a bottom section 15, a top section 14 pivotally attached together by a hinge 16, and a light housing 20. The bottom section 15 provides a customizable greeting message posting area 13 and a half-ball detent 12 as part of a switch mechanism. The top section 14 has an extended portion in its front end to accommodate the light housing 20.

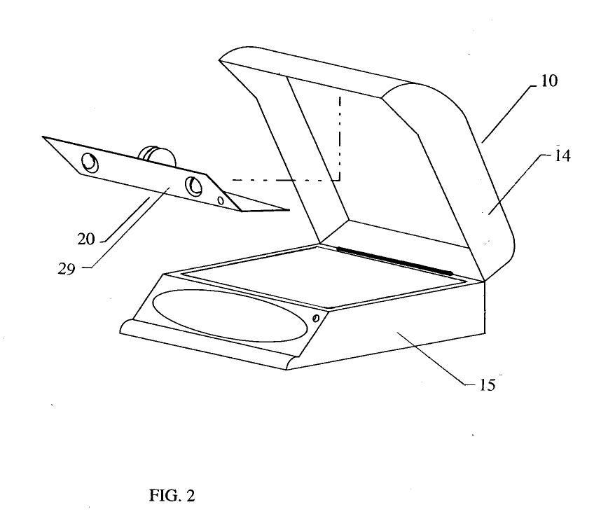

Referring to FIG. 1 and FIG. 2. In the FIG. 2, the light housing is separated from the top section 14. The light housing 20 includes a housing panel 29. The housing panel has two light holes with reflector 21 and 23, and a switch hole 25. The LED light bulbs 22 and 24 are mounted on the light holes 21 and 23 respectively. The LED lights are pointing to the jewelry presenting area 11 from its slightly top right and slightly top left directions.

To look closely of the light housing 20, FIG. 3 shows the back view of the light housing 20. The power source(batteries) 40 is connected to a conductive detent 33 by a wire 42. The conductive detent 33 is tapped by the flexible conductive strip 31. The flexible conductive strip 31 is connected to one of the leg of the LED 24 by a wire 43. The complete circuit is then continuously from the other leg of the LED 24 to the LED 22, and going back to the batteries 40 by the wire 44 and 45 respectively.

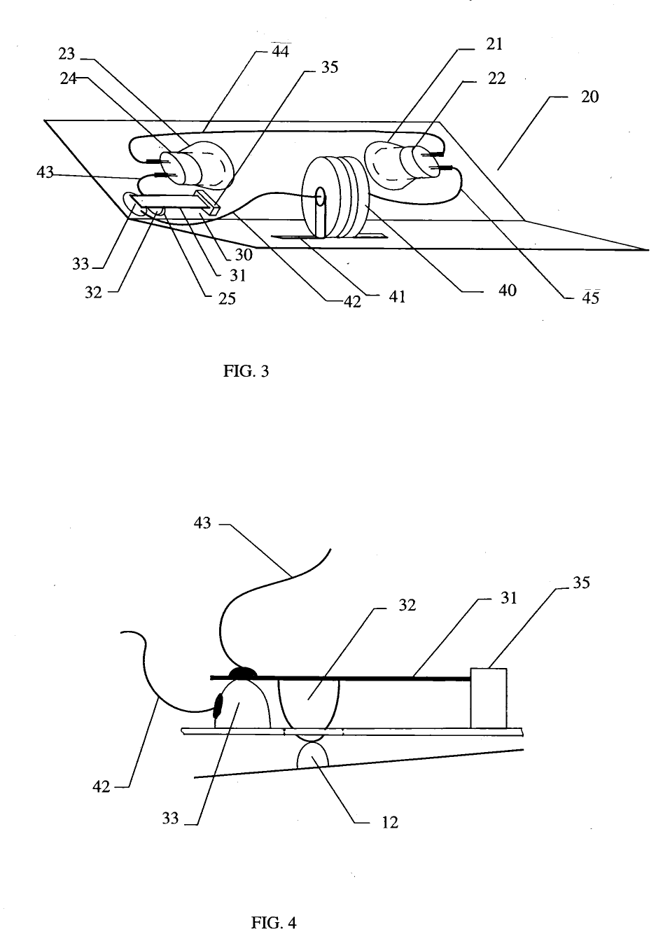

Referring to FIG. 3 and FIG. 4. FIG. 4 shows the side view of the switch mechanism 30. One end of the flexible conductive strip 31 is mounted on a non-conductive support station 35. There is half-ball detent 32 beneath the flexible conductive strip 31 and it sticks through the switch hole 25 a little bit. In the closed circuit mode, the flexible conductive strip 31 is tapping on the conductive bump 33 when the jewelry box 10 is in the open position, therefore the electrical current will flow from the power source 40, through the switch 30, through two LED lights and finally back to the power source 40. Because the half-ball detent 12 is located in correspond position of the switch hole 25, when the top section 14 is closing down, the half-ball detent 12 will push the flexible conductive strip upward. Therefore the power source will be cut off.

1. An integrated greeting message and lighted jewelry box comprising,
a bottom section with greeting message posting area,
a top section with extended portion for lighting,
hinge means connecting said bottom section with said top section,
a light housing located within said top section for selectively illuminating at least said bottom section.

2. The light housing recited in claim 1 including,
a housing panel which has two lighting holes with reflectors and a switch hole,
two LED lights mounted on said lighting holes,
power source setting on the top of said housing panel,
a switch mechanism is mounted on the top of said housing panel.

3. The switch mechanism said in claim 2 including,
a flexible conductive strip with a half-ball detent,
a non-conductive support station,
one conductive detent on said housing panel to connect a electrical wire.
One end of said flexible conductive strip is mounted on said non-conductive support station. The other end of said flexible conductive strip is tapped on said conductive detent. Said half-ball detent attached to said flexible conductive strip sticks through said switch hole in claim 2.

4. The bottom section recited in claim 1 includes a small half-ball detent. Its location corresponds with said half-ball detent in claim 3. When the top section is closed down, said small half-ball detent will push said flexible conductive strip off said conductive detent, the power source will then be cut off.
